(19) United States
(12) Patent Application Publication
(10) Pub. No.: US 2013/0260156 A1
(43) Pub. Date: Oct. 3, 2013

(54) SURFACE COATING WITH PERFLUORINATED COMPOUNDS AS ANTIFOULING

(71) Applicants: Serena Biella, Milano (IT); Giuseppe Cattaneo, Sirone (LC) (IT); Pierangelo Metrangolo, Pioltello (MI) (IT); Giuiseppe Resnati, Monza (IT)

(72) Inventors: Serena Biella, Milano (IT); Giuseppe Cattaneo, Sirone (LC) (IT); Pierangelo Metrangolo, Pioltello (MI) (IT); Giuiseppe Resnati, Monza (IT)

(73) Assignee: S.T. SPECIAL TANKS SRL, Annone di Grianza (LC) (IT)

(21) Appl. No.: 13/990,237

(22) PCT Filed: Nov. 30, 2011
(86) PCT No.: PCT/IB11/55379

§ 371 Date: May 29, 2013

(30) Foreign Application Priority Data
Nov. 30, 2010 (IT) MI2010A002217

(51) Int. Cl. C09D 5/16

(52) U.S. Cl. CPC C09D 5/1625
USPC 428/422; 427/384; 558/186; 556/419

(57) ABSTRACT

The present invention relates to the use of perfluorinated compounds as a surface coating to counteract the formation of fouling. The present invention also relates to a method for producing a surface coating capable of preventing the formation of fouling, this method comprising the application of a polar solution of a perfluorinated compound followed by a heat cycle conducted at controlled temperatures.

### FIELD

The present invention relates to the use of perfluorinated compounds as a surface coating to counteract the formation of fouling. The present invention also relates to a method for producing a surface coating capable of preventing the formation of fouling, this method comprising the application of a polar solution of a perfluorinated compound followed by a heat cycle conducted at controlled temperatures.

### BACKGROUND

The behavior of materials in the various fields in which they are applied is very frequently dependent on the surface and interface conditions. Properties such as wettability and the coefficient of friction are closely linked to the distinctive features of any given substrate; it has also been demonstrated that the first atomic layers of the interface are very different in their composition and structure from what would be expected on the basis of the mass composition, but it is these characteristics that determine the surface properties of a given material. Consequently, attempts have been made to control and engineer the surface characteristics of materials, by means of techniques for modifying the surface externally (using coatings of various kinds which meet the requisite specifications) and for internal modification (by acting directly on the microstructure of the material). The use of coatings for surface modification is a procedure which has been widely adopted in recent years, because the development of a new material devised on an ad hoc basis for a specific application requires a more time- and labour-intensive process that is not justified by the expected results. By using coatings, however, it is possible to modify the surface only, without in any way affecting the mass properties of the material concerned.

Furthermore, it has been known for some time that the problem of fouling, in other words the problem of “contamination” or “incrustation”, is widespread in many industrial fields and causes very considerable losses in terms of costs and maintenance of equipment such as heat exchangers, reservoirs, pipes, and hulls of vessels. The term “fouling” denotes the phenomenon of the accumulation and deposition of living organisms (biofouling), whether animal or vegetable, or other materials, on hard surfaces. More specifically it relates to encrustations which cover the surfaces of objects which have been submerged in aqueous and marine environments (marine fouling), such as the hulls of boats, products made from stone, metal or timber, and concrete structures directly wetted by the sea. This is due to the action of microscopic and other animal or vegetable organisms which develop on the immersed parts of structures. Fouling is also a cause of catalyst inactivation. Traditionally, biofouling has been counteracted by the use of antifouling paints which have a biocidal action; however, a non-biocidal approach to the resolution of the fouling problem has been developed recently in response to the latest legislation. In the field of industrial installations (in chemical engineering, for example), the term fouling denotes the progressive contamination of the inner walls of tubes for carrying fluids (or inside chemical apparatus), caused for example by calcareous encrustation or deposition of particles suspended in fluid. The fouling process adversely affects heat exchange, thus reducing the overall heat exchange coefficient, and in the most severe cases may result in the swelling and bursting of a tube. Fouling also modifies the roughness of the tube and therefore increases the pressure drop which the fluid undergoes. Factors which affect fouling include the temperature of the fluid (the process of lime formation in water is accelerated at high temperatures) and other chemical and physical properties of the fluid (such as the hardness of the water), while the geometry of the piping and/or of the installation (for example, the presence of bends or constrictions) also plays an essential part.

Hitherto, various operating methods and different implementation procedures have been considered in attempts to remedy the problem of fouling. Attempts have been made to prevent the formation of fouling by making a careful choice of piping material, or by increasing the flow velocity. If it is impossible to eliminate or reduce the formation of fouling by means of the arrangements described above regarding construction, it is possible to remove deposits by mechanical or chemical cleaning, using procedures and/or products which are often aggressive. Clearly, therefore, the prior art does not offer any simple solution which would prevent the formation of fouling.

### BRIEF DESCRIPTION OF THE DRAWINGS

FIG. 1 is an XPS analysis of a coated metal surface.

FIG. 2 is an XPS analysis of a coated glass surface.

FIG. 3 is an XPS analysis of a coated and aged metal surface.

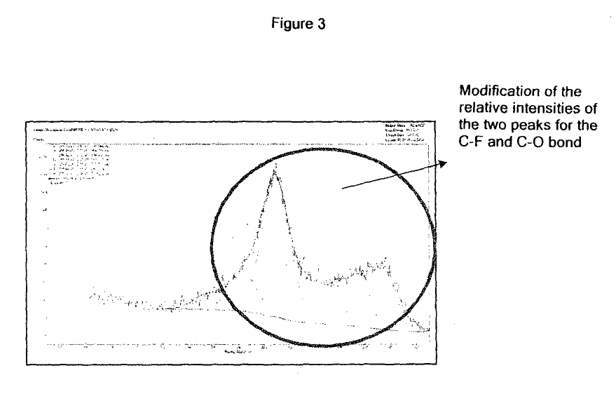

FIG. 4 is an IR analysis of a coated metal surface.

FIG. 5 is an SEM analysis of a coated metal surface.

FIG. 6 is an SEM analysis of a coated metal surface and chemical analyses.

### DETAILED DESCRIPTION

Accordingly, it was considered desirable to study the behaviour of some metals, particularly steel, in the presence of a coating which would improve their performance in specified conditions. The aim was to form a very thin coating or covering (at the nanometric scale) on specimens of carbon steel and stainless steel (AISI 304 and AISI 316), in order to optimize the behaviour of these materials in the presence of fouling of various kinds, particularly precipitation fouling.

The purpose of the investigation was to avoid any interaction of the steel with harmful precipitates and to facilitate the washing of the surface of the specimens. The aim was therefore to optimize certain parameters such as the hydrophobicity of the coating, the adhesion to the substrate, and the durability in aggressive operating conditions.

Our objective was to investigate a protective coating which would provide good protection against fouling for the steel substrate, with a sustainable effect on production costs, the aim being to optimize both the costs and the efficiency of the treatment. Surprisingly, it was found that some perfluorinated compounds could be used successfully as surface coatings in order to prevent the formation of fouling.

The term “surface” according to the present invention denotes a metal surface, such as carbon steel or alloy steel, stainless steel or duplex stainless steel, nickel and its alloys, copper and its alloys, aluminium and its alloys, titanium and its alloys, or a glass surface, a plastic material; or a plastic textile or fibre and/or their derivatives.

The present invention therefore proposes the use of at least one perfluorinated compound as antifouling.

A perfluorinated compound has at least one, or preferably two, functional groups capable of interacting specifically with different surfaces. Such a functional group may be an amide, a phosphate and/or a silane, preferably a silane.

A perfluorinated compound which is particularly preferred for the purposes of the present invention has a chemical structure containing ethoxysilane terminal groups which, by interacting chemically with the —OH groups present on the substrates to which the compound is applied, give the compound good adhesion on a very wide range of surfaces, such as those made of metal, glass, silicon-based materials, metal oxides, polyurethane and polycarbonate polymers. This compound imparts to the substrate the typical properties of innovative composite materials such as a better weight to strength ratio than those of other materials and a high chemical and thermal resistance. Application of this compound can produce a very thin permanent coating layer; the thickness of the layer does not affect the performance of the treatment and is usually equal to a few molecular layers.

Its molecular structure can be represented as follows:

F—[OCF₂]ₙ[OCF₂CF₂]ₚ—F

where:
F is a functional group selected from among amide, phosphate and silane,
the sum n+p is in the range from 9 to 15,
and the ratio p/n is preferably in the range from 1 to 2.

The preferred perfluorinated compound according to the present invention is therefore a perfluoropolyether. A preferred molecular structure according to the present invention is:

(NH₄)₂PO₄—[C₂H₄O]ₘ—CH₂—R_{F}—CH₂—[OC₂H₄]ₘ—PO₄(NH₄)₂

where:
R_{F}═[OCF₂]ₙ[OCF₂CF₂]ₚ,
m is in the range from 1 to 2,
the sum n+p is in the range from 9 to 15,
and the ratio p/n is preferably in the range from 1 to 2.

Another preferred molecular structure according to the present invention is:

(EtO)₃Si—CH₂CH₂CH₂—NHC(O)—CF₂—R_{F}—OCF₂C(O)NH—(CH₂)₃—Si(OEt)₃

where:
R_{F}═[OCF₂]ₙ[OCF₂CF₂]ₚ,
the sum n+p is in the range from 9 to 13,
and the ratio p/n is preferably in the range from 1 to 2.

The aforementioned perfluoropolyethers are available commercially under the trade names Fluorolink® S10 and Fluorolink® F10, respectively.

In particular, Fluorolink® S10 has, among other characteristics, certain typical properties of perfluoropolyethers which make it highly stable. These include a low glass transition temperature (approximately −120° C.), chemical inertia, resistance to high temperatures and solvents, and barrier properties. Some physical properties of Fluorolink® are shown in Table 1 below.

TABLE 1

| Functional groups | — | Silane |
|---|---|---|
| Average molecular weight | amu | 1750-1950 |
| Colour | — | Pale yellow |
| Appearance | — | Clear or |
| | | transparent liquid |
| Density (at 20° C.) | g/cm³ | 1.51 |
| Kinematic viscosity (at 20° C.) | cst | 173 |
| Refractive index (at 20° C.) | — | 1.35 |

The present invention also proposes a metal or glass surface or a plastic material, preferably the inner or outer wall of a heat exchange and/or transfer apparatus, or of any apparatus for containing and/or transferring substances, or more preferably of a heat exchanger.

The metal or glass surface is coated with a perfluorinated compound, preferably a perfluoropolyether.

The present invention also proposes a method for obtaining a coated surface, comprising the following steps:

a) application of a polar solution of a perfluorinated compound to a surface;

b) heat treatment of the surface thus coated.

In order to obtain the aforesaid coating, the perfluorinated compound, preferably a perfluoropolyether, such as Fluorolink® S10, is dissolved in a polar solvent, preferably an alcohol or water or a mixture thereof. A preferred alcohol according to the present invention is isopropyl alcohol.

The percentage by weight of the perfluorinated compound present in the solution according to the present invention is in the range from 0.1% to 20%, preferably from 0.5% to 15%, even more preferably from 0.5% to 10%, with respect to the total weight of the solution.

Additionally, the solution can if necessary contain a catalytic quantity of organic or inorganic acid, but is preferably organic, or even more preferably acetic acid. This acid can be present in the aforesaid solution of perfluorinated material in a quantity by weight in the range from 0.05% to 5%, preferably from 0.5% to 2%, relative to the solution.

This perfluorinated compound is then applied to the surface to be treated, for example by brushing the surface, by immersion, or by spraying.

According to the present invention, the surface coated with the aforesaid solution containing the perfluorinated compound is subjected to a heat treatment in the form of heating and drying in a single step to a temperature of less than 150° C., preferably less than 100° C., or even more preferably in the range from 40° C. to 90° C. The duration of this heat treatment is less than 24 hours, or preferably in the range from 14 to 23 hours.

In order to determine the hydrophobicity of the surface covered with the aforesaid coating, in other words the tendency of the surface to be water-repellent, the contact angle was measured before and after coating. The contact angle measurements can be used to determine the surface energy of the perfluorinated compound under investigation.

The term “contact angle” denotes the angle, in degrees, formed by the horizontal surface with the tangent to the drop at the contact point.

The following table shows the contact angles measured on an uncoated metal surface.

TABLE 2

| Symbol | Mean contact angle (°) |
|---|---|
| Carbon steel | 68.1 |
| AISI 304 | 62.4 |
| AISI 316 | 60.4 |

After the aforesaid surface had been subjected to heat treatment according to the invention, the contact angles were measured and were found to be comparable with those obtained after heat treatment that had been carried out according to the prior art in two steps as follows: 30 minutes at 100° C. and 15 minutes at 150° C.

This finding therefore demonstrates that the aforesaid surface becomes water-repellent after the heat treatment according to the present invention.

The contact angles in question are preferably in the range from 80° to 150°, or more preferably from 90° to 130°.

The coating containing the aforesaid perfluorinated compound was then tested for stability in response to various parameters, namely mechanical action, resistance to flowing water, contact with saline solutions, and high temperatures, as described in the experimental section.

We also set up the hypothesis that a monomolecular surface coating was present. Two surface analyses, by means of XPS (X-Ray Photoelectron Spectroscopy) and AFM (Atomic Force Microscopy), were conducted in order to test this hypothesis. As described in the experimental section, it was found that the coating mechanism depended on the nature of the treated surface, in other words whether the surface was metal or glass.

In the case of a metal surface, the coating was monomolecular and therefore had a thickness of a few nm.

In these conditions, there is little perceptible change in the mass properties of the coated material, but the added protective layer should prevent the formation of fouling.

Unlike ordinary paints typically used in marine applications, the treatment proposed by us has a thickness which is smaller by several orders of magnitude.

Finally, the fouling resistance of these coatings was evaluated by leaving various coated specimens in buffered pH tap water, in sea water, and in river water. The contact angle remained unchanged, in other words within the range from 80° to 150°, thus confirming the resistance of the coating to fouling.

### EXPERIMENTAL SECTION

### Preparation of the Specimens

It was decided that specimens of carbon steel and stainless steel (AISI 304 and AISI 316) would be used. The coating was applied on test sheets or specimens measuring 2 cm×1 cm. Some test specimens were prepared in an appropriate way before the application of the coating, by carrying out initial cleaning with water and acetone to remove the coarser impurities on the specimens, after which the surfaces of the specimens were made as nearly perfect as possible by immersing them in CH₂Cl₂ for one minute while stirring with a magnetic stirrer.

This operation was carried out in order to improve the efficiency of the method of cleaning the specimen by providing turbulence in the proximity of the surface of the specimen.

The coating was also applied to unwashed specimens, in order to reproduce an industrial process as closely as possible. It was found that there were no significant differences between the contact angles after the specimens had been coated and heat-treated, thus demonstrating that the step of pre-washing the specimens was not necessary.

The specimens subjected to washing were allowed to dry under a hood for the time required to prepare them for the application of the coating.

The products used were deposited on the surfaces of the specimens by two different methods:
by simple brushing on to the surface of the specimen;
by immersion of the specimen in a beaker containing the product used.

An alcohol solution with the following composition in terms of volume was produced:
1% by weight of Fluorolink® S10
4% by weight of distilled water
1% by weight of acetic acid
64% of isopropyl alcohol

After the application of the coating, the specimens were subjected to a thermal cycle (100° C. for 30 minutes. followed by 150° C. for 15 minutes) or heat treatment in a single step at a temperature of at least 50° C., for heating and drying. Two different heating methods were used:

a) by contact on a heating plate;
b) in an oven.

In both cases, the heating process took place in the presence of oxygen and both methods yielded the same results.

The contact angles were measured on the specimens treated in this way, as shown in Table 3.

TABLE 3

| Symbol | Contact angle (°) |
|---|---|
| AISI 304 S10 | 114.4 |
| AISI 316 S10 | 130.5 |

Evidently, the post-deposition heat treatment markedly improves the water-repellence of the surface.

We made a preliminary comparison of the results obtained with test specimens treated with formulations based on fluorinated molecules in alcoholic and aqueous solution.

Using an aqueous solution containing 1% by weight of perfluoropolyether and 1% by weight of acetic acid (required for the acid catalysis of the process), with the remaining part by weight accounted for by distilled water only, we found values of the contact angle comparable with the alcohol solution containing the same percentages of perfluoropolyether and acetic acid.

The metal specimen was subjected to a heating and drying treatment, by a two-step process known in the prior art (30 minutes at 100° C., 15 minutes at 150° C.), or by a one-step process at a temperature of approximately 80° C.

The mean value of the contact angle was approximately 120°.

The treated metal specimens were specimens of AISI 304 and AISI 316 steel and plain steel.

The treated specimens were washed and coated, but some of them were coated without washing.

No significant differences in the contact angle were observed.

The specimens were coated by simple immersion and by brushing, but no significant differences were observed.

The same specimens were analysed by the XPS method and showed a typical spectrum (with one low energy zone typical of C—O bonds and another one typical of C—F bonds).

Consequently, all the specimens prepared subsequently were subjected to a post-deposition thermal annealing treatment.

Ageing tests at high temperature were conducted to evaluate the strength of the coating obtained. The specimens were placed in a sealed thermostatic chamber and brought to a temperature of 160° C. which was maintained for 12 hours. The chamber was connected to an IR spectrometer so that the evolution of any decomposition gas from the analysed materials at high temperature could be recorded. The analyses did not reveal any evolution of gaseous decomposition products from the specimens that had been treated by surface coating, confirming the stability at high temperature of the treatments carried out on the specimens used and treated as described above. Further confirmation was provided by re-analysing the same specimens subject to high temperature treatment, by measuring the contact angle of a drop of water, in order to evaluate any changes in the protective surface layer.

The contact angles measured in this way were found to be unchanged and stable. In order to assess the stability of the coatings when subject to mechanical action, the surface was rubbed manually with a sheet of absorbent paper, in both wet conditions (using water) and dry conditions.

The mean contact angle did not change significantly from the previous measurement, thus demonstrating a good resistance of the coating to mechanical erosion.

In a second step, the specimens coated according to the above specifications were subjected to a preliminary test of resistance to flowing water by immersing them in a bath containing tap water from the Milan mains supply, with continuous stirring at ambient temperature, for one week.

At the end of this treatment, the contact angle of the water drop was re-measured in order to assess any changes in the performance of the applied surface coating as a result of abrasion or possible reconstruction. The mean measurements are shown in the following table:

TABLE 4

| Symbol | Contact angle (°) |
|---|---|
| AISI 304 S10 | 92.5 |
| AISI 316 S10 | 93.0 |

The data in the table indicates that the contact angle tends to decrease slightly relative to the coated specimens that were not subjected to this treatment, although the values of the contact angle that were maintained were excellent by comparison with those of specimens that were not treated with the coating agents.

Similarly, some previously coated stainless steel specimens were left for one week at 80° C. in buffered pH mains water (pH 9), in river water and in sea water.

The various contact angles were measured, and the following results were obtained:

TABLE 5

| Type of water | Contact angle (°) |
|---|---|
| Tap water at pH 9 | 120° |
| River water | 115° |
| Sea water | 80° |

Uncoated stainless steel specimens were left in the same conditions, and contact angles of about 80° were found.

New, freshly prepared coated specimens were then subjected to a test of resistance to contact with saline solutions.

For this purpose, a concentrated solution containing NaHCO₃, K₂CO₃ and NaCl was prepared from 2.5 L of H₂O, 24 g of NaHCO₃, 100 g of K₂CO₃ and 89 g of NaCl. The freshly coated specimens were immersed in this solution for one week with constant stirring at ambient temperature.

At the end of this treatment, the surfaces of the specimens were partially covered with aggregated salt crystals. It was found that a simple brushing of the surfaces was sufficient to remove these crystal aggregations from the surfaces of the treated specimens, while this salt layer was difficult to remove by brushing the surfaces of similar specimens which were untreated and were subjected to the same test by being left in an aqueous solution with a high salt content. The salt layer deposited on the treated specimens was easily removed by washing under flowing water, and this restored the water-repellent performance of the coating, as demonstrated by the mean values of the contact angle shown in the table.

TABLE 6

| Symbol | Contact angle (°) |
|---|---|
| AISI 304 S10 | 104.0 |
| AISI 316 S10 | 91.0 |

These results clearly show that both of the treatments which were carried out improved the water-repellent performance of the initial materials. Preliminary tests yielded unequivocal proof that these treatments conferred properties which were stable over time and resistant to friction, to high temperatures, and to prolonged exposure to aqueous solutions with a high salt content.

It should be noted that the mean contact angles of the specimens before coating were around 60-70°, while the contact angles of the coated specimens in general were in the range from 115° to 130°.

The possibility of a release of fluorine in solution was also investigated, by leaving a coated stainless steel specimen in water (50 ml of distilled water) for one week at ambient temperature. The analysis was conducted with a Metrohm 883 ion chromatograph and the results showed a total absence of any release of fluorine in solution.

In order to determine the nature of the coating mechanism, “mirror polished” AISI 316 steel surfaces and a glass surface were also investigated. The “mirror polished” 316 steel was produced by abrasion of the metal surface with suitable abrasive papers. The aim of this procedure was to make the surface as uniform as possible at the micrometric level and thus to reduce the differences in profile found at the surface level. This specimen has a smaller contact angle than that of the non-mirror-polished series, both before coating (60°) and after coating (maximum recorded value 105°).

The specimen which took the form of a glass surface had an initial contact angle of 46°, while the value was 109° after the treatment.

### Surface Analysis

In order to test the hypothesis concerning the nanometric nature of the coating, we conducted two different surface analyses, namely an XPS analysis and an AFM analysis.

The results of these analyses showed that fluorine (the investigated element) could be found on all the specimens, and that an estimate of the surface thickness of the coating could also be made.

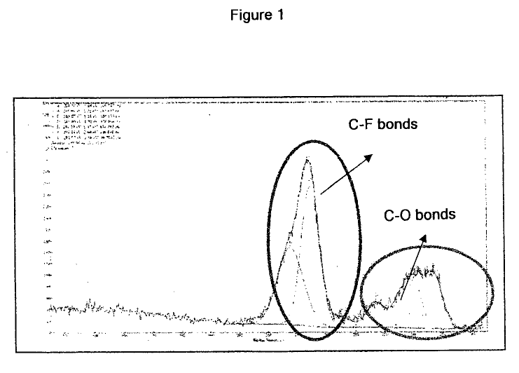

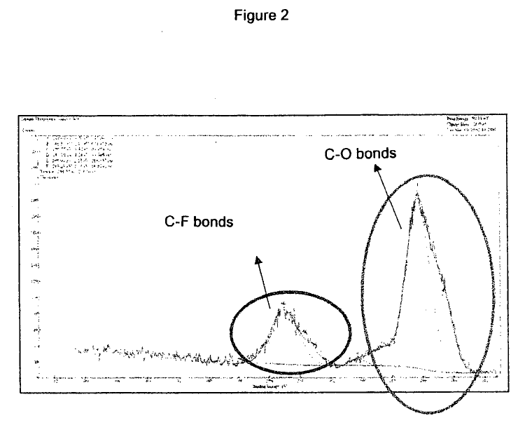

Using the XPS method (which has a maximum surface investigation field of 40 Å), it was found that the coating mechanism on the metal surfaces differed from the mechanism on the glass surfaces. In particular, the part of the deconvolution spectrum relating to the C—F bonds was predominant on the metal surfaces, while the part of the deconvolution spectrum relating to the C—O bonds was predominant on the glass surfaces (FIGS. 1 and 2). This behaviour can be related to the fact that the cross-linking of the fluorinated molecule is better on the metal surface than on the glass surface. A possible reason for this is that the fluorinated molecules arrange themselves parallel to each other on the metal surface, thus covering the surface in a uniform and compact way.

The XPS analysis did not reveal any iron in any of the steel specimens, because the surface coating layer was uniform and thicker than 40 Å.

Similar results were found by AFM analysis. The profile of the metal specimens was analysed by scratching the surface, and in all cases a fluorinated surface layer was found. The thickness of this layer was also estimated by quantitative analysis (conducted with a calibration curve at two points only) and was found to be approximately 50 nm.

The behaviour of the mirror-polished specimens was found to be different from that described above, in both XPS and AFM analysis.

XPS analysis showed iron, as well as fluorine, on the surface. It is probable that these specimens were coated in a non-uniform way and there was certainly a thinner surface layer. This hypothesis was confirmed by the AFM analysis, in which the thickness of fluorinated material was found to be approximately 15 nm. The AFM analysis also revealed a non-uniform coating, with the photographs showing whole surface regions without any fluorinated molecules. XPS analysis also revealed that the coating of these specimens was less stable, since fluorine was found on a sacrificial specimen placed in the analysis chamber. This phenomenon can be explained by the mechanism of the deposition on the sacrificial specimen of the fluorine detached from the mirror-polished steel specimen.

On the other hand, the non-mirror-polished specimens did not show this behaviour. The hypothesis proposed by us to explain this behaviour is that the mirror-polishing of the metal surface causes a decrease in the surface anchoring groups required for a complete bond between the fluorinated molecule and the surface. Finally, an aged specimen of AISI 316 (left under a hood in an uncontrolled atmosphere for several months) was investigated by the XPS method.

This specimen showed the presence of fluorine (demonstrating the durability of the coating) but also had a non-“classic” spectrum (that is to say, a spectrum different from the image in FIG. 1) which was more similar to that of the glass material (that is to say, the image shown in FIG. 2).

The hypothesis proposed by us is that ageing causes a restructuring of the surface layer and that the peak intensity relations for the C—F and C—O are modified as a result. Additionally, the results of the quantitative XPS analysis (estimate of the C/F ratio) indicate a trend relating to the values of the contact angles of the metal specimens.

In order to confirm our hypothesis, we attempted to provide a detailed analysis of the nature of the interactions and/or chemical bonds between the molecule used for the coating and the metal surface. The aim of this analysis was to understand the anchoring mechanism between the coating and the substrate in order to improve the performance of the coating.

The first analysis conducted was an IR analysis on the surface of a stainless steel specimen (AISI 304) to determine the chemical nature of the compound deposited on the metal surface.

We used an IR system coupled to a Continuμm microscope in double transmission mode with a resolution of 4 cm⁻¹ and 64 scans.

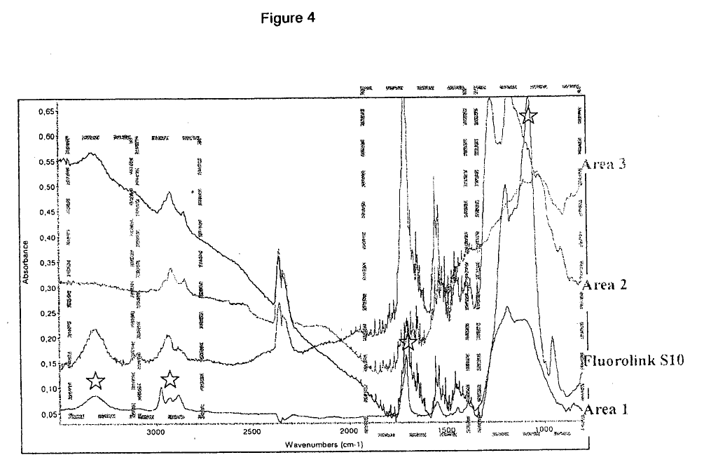

In this analysis we studied different areas of the specimen, and FIG. 4 shows the results for three different areas (identified as Area 1, Area 2 and Area 3).

The spectrum (coloured red) relates to the pure Fluorolink S10 product and, as can be seen, the significant peaks of this molecule (marked with the symbol ⋆) are present in all the investigated areas.

This demonstrates that the molecule used by us for the coating is unquestionably present on the surface and does not undergo any chemical alteration during the process of adhesion and binding to the surface. We attempted to use other spectroscopic methods (IR grazing angle, a useful analytical method for thin films), but the results were not considered reliable because of the roughness of the analysed specimens.

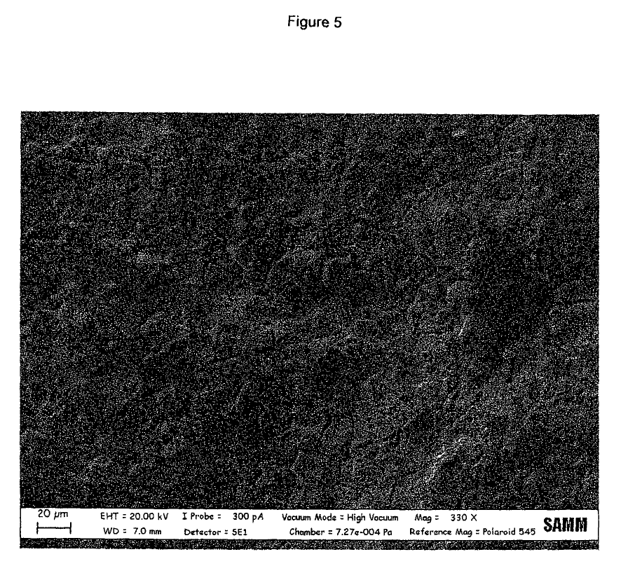

The nanostructured nature of the coating was further investigated by SEM (Scanning Electron Microscope) analysis. The analysis provided a surface image as well as a chemical analysis of the atoms present in the first surface layers. FIG. 5 shows an image of the coated metal surface.

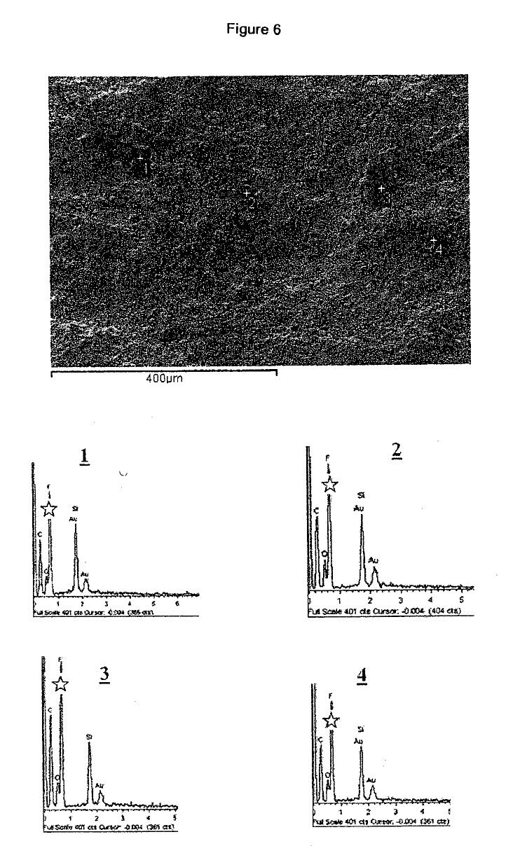

It is immediately evident that the surface has islands of coating product. These islands were analysed in detail to determine the nature of the constituent atoms of these agglomerations. FIG. 6 shows a second image of a coated stainless steel specimen and the corresponding chemical analyses of points 1, 2, 3 and 4. Evidently, fluorine is present in all the islands photographed in image 3. The same analysis conducted in unmarked areas of image 3 did not yield any significant results. Consequently we cannot exclude the presence of a thin film over the whole surface. The SEM-EDS analysis has the problem, in analytical terms, that the signals of fluorine and iron (an element present in larger percentages in the steel specimen) fall to very similar energy levels (making is difficult to separate the two contributions). The presence of a thin film means that these two elements cannot be discriminated, although fluorine is certainly present in a smaller percentage. However, in concave areas, where an accumulation of fluorinated material is found, it is possible to identify the presence of fluorine. However, the analysis conducted with the IR microscope indicated the presence of the Fluorolink S10 molecule on all points of the investigated surface. We can therefore assume that a thin film extending over the whole surface was present, although this characteristic cannot be proved by a single analysis.

In order to confirm the results obtained with different types of water during the first part of the contract, we re-tested sheets coated with a thin layer of Fluorolink S10 in basic pH and acid pH solutions and in sea water.

The tests were conducted in static conditions at ambient temperature and at high temperature.

The data for a number of coated specimens, immersed for 30 or 54 hours in a basic solution at pH 9 at ambient temperature or at 60° C. are shown below.

TABLE 7

| | | Tamb36 | | |
|---|---|---|---|---|
| TEST | Tamb (30 h) | (54 h) | T 60° C. (30 h) | T 60° C. (54 h) |
| 1 | 117.3 | 90.6 | 140.7 | 104.8 |
| 2 | 101.1 | 78.9 | 146.3 | 122.4 |
| 3 | 111.2 | 90.2 | 136.2 | 135.4 |
| 4 | 99.9 | 99.5 | 129.6 | 129.3 |
| 5 | 105.2 | | 134.5 | 121.3 |
| Mean value (°) | 106.94 | 89.8 | 137.46 | 122.64 |

This test proved that temperature played a fundamental part in the preservation of the protective surface layer.

We then conducted tests in an acid solution. In this case, the results for ambient temperature only are available, and comparisons with high temperature cannot be made. The data for a number of coated specimens, immersed for 30 or 100 hours in an acid solution at pH 5 at ambient temperature, are shown below.

TABLE 8

| TEST | T amb (30 h) | T amb (100 h) |
|---|---|---|
| 1 | 105.7 | 107 |
| 2 | 110.1 | 111.7 |
| 3 | 109.3 | 103.7 |
| 4 | 111.4 | 105.7 |
| 5 | 118.8 | 111.8 |
| 6 | 105.9 | 106.5 |
| Mean value (°) | 110.2 | 107.733 |

A drop of these solutions with acid or basic pH (at different concentrations) was then deposited on some coated AISI 304 test specimens, using a Pasteur pipette and delimiting the area contacted by the drop. After about one hour, when the drop had evaporated, the contact angle on the test specimens, which had been kept under a hood, was measured in the area of the drop and in the contiguous areas which had not been in contact with the drop.

Specimen A (mean value (°)=123.17)→
pH 1→drop area θ=22.3°
area outside the drop θ=82.9°

Specimen B (mean value (°)=127.625)→
pH 5→drop area θ=93.6°
area outside the drop θ=121.8°

Specimen B (mean value (°)=115.65)→
pH 12→drop area θ=60.90°
area outside the drop θ=135.2°

Specimen B (mean value (°)=128.025)→
pH 9→drop area θ=85.7°
area outside the drop θ=122.2°

When the contact angles had been measured, the areas treated with acid and basic solutions were treated with a solution of Fluorolink S10 at 0.5% by weight (in aqueous solution) and were subjected to the conventional heat treatment at 80° C. for a period of more than 15 hours. The contact angles of these new “restructured” surfaces were then measured. The final values obtained are comparable to those present before the treatment, thus demonstrating the ease with which the protective surface layer can be repaired.

1-12. (canceled)

13. A antifouling method comprising:
using a perfluorinated compound, wherein the perfluorinated compound has a chemical structure of F—[OCF₂]ₙ[OCF₂CF₂]ₚ—F, wherein F is a functional group selected from among amide, phosphate and silane, wherein sum of n+p is in a range from 9 to 15, and wherein ratio of p/n is in range from 1 to 2.

14. The antifouling method according to claim 13, wherein the perfluorinated compound has a chemical structure of (NH₄)₂PO₄—[C₂H₄O]ₘ—CH₂—R_{F}—CH₂—[OC₂H₄]ₘ—PO₄(NH₄)₂, wherein R_{F}═[OCF₂]ₙ[OCF₂CF₂]ₚ, wherein m is in a range from 1 to 2, wherein sum of n+p is in a range from 9 to 15, and wherein ratio of p/n is in a range from 1 to 2.

15. The antifouling method according to claim 13, wherein the perfluorinated compound has a chemical structure of (EtO)₃Si—CH₂CH₂CH₂—NHC(O)—CF₂—R_{F}—OCF₂C(O)NH—(CH₂)₃—Si(OEt)₃, wherein R_{F}═[OCF₂]ₙ[OCF₂CF₂]ₚ, wherein sum of n+p is in a range from 9 to 13, and wherein ratio of p/n is in a range from 1 to 2.

16. A surface coated with a perfluorinated compound, wherein the perfluorinated compound has a chemical structure of F—[OCF₂]ₙ[OCF₂CF₂]ₚ—F, wherein F is a functional group selected from among amide, phosphate and silane, wherein sum of n+p is in a range from 9 to 15, and wherein ratio of p/n is in a range from 1 to 2.

17. The surface according to claim 16 wherein the perfluorinated compound has a chemical structure of (NH₄)₂PO₄—[C₂H₄O]ₘ—CH₂—R_{F}—CH₂—[OC₂H₄]ₘ—PO₄(NH₄)₂, wherein R_{F}═[OCF₂]ₙ[OCF₂CF₂]ₚ, wherein m is in a range from 1 to 2, wherein sum of n+p is in a range from 9 to 15, and wherein ratio of p/n is in a range from 1 to 2.

18. The surface according to claim 16, wherein the perfluorinated compound has a chemical structure of (EtO)₃Si—CH₂CH₂CH₂—NHC(O)—CF₂—R_{F}—OCF₂C(O)NH—(CH₂)₃—Si(OEt)₃, wherein R_{F}═[OCF₂]ₙ[OCF₂CF₂]ₚ, wherein sum of n+p is in a range from 9 to 13, and wherein ratio of p/n is in a range from 1 to 2.

19. The surface according to claim 16, wherein said surface includes metal, glass or plastic.

20. The surface according to claim 16, wherein the surface is an inner or an outer wall of an apparatus that exchanges and/or transfers heat or of any apparatus that contains and/or transfers substances.

21. The surface according to claim 20, wherein the apparatus is a heat exchanger.

22. The surface according to claim 16, wherein the surface has a contact angle in a range from 80° C. to 150° C.

23. The surface according to claim 22, wherein the surface has a contact angle in a range from 90° C. to 130° C.

24. A method for obtaining a coated surface, comprising:
applying a polar solution including a perfluorinated compound to a surface; and
heat treating the surface;
wherein the wherein the perfluorinated compound has a chemical structure of F—[OCF₂]ₙ[OCF₂CF₂]ₚ—F, wherein F is a functional group selected from among amide, phosphate and silane, wherein sum of n+p is in a range from 9 to 15, and wherein ratio of p/n is in a range from 1 to 2.

25. The method according to claim 24, wherein the perfluorinated compound has a chemical structure of (NH₄)₂PO₄—[C₂H₄O]ₘ—CH₂—R_{F}—CH₂—[OC₂H₄]ₘ—PO₄(NH₄)₂, wherein R_{F}═[OCF₂]ₙ[OCF₂CF₂]ₚ, wherein m is in a range from 1 to 2, wherein sum of n+p is in a range from 9 to 15, and wherein ratio of p/n is in a range from 1 to 2.

26. The method according to claim 24, wherein the perfluorinated compound has a chemical structure of (EtO)₃Si—CH₂CH₂CH₂—NHC(O)—CF₂—R_{F}—OCF₂C(O)NH—(CH₂)₃—Si(OEt)₃, wherein R_{F}═[OCF₂]ₙ[OCF₂CF₂]ₚ, wherein sum of n+p is in a range from 9 to 13, and wherein ratio of p/n is in a range from 1 to 2.

27. The method according to claim 24, wherein the polar solution is an alcoholic and/or aqueous solution.

28. The method according to claim 24, wherein the polar solution has a percentage by weight of the perfluorinated compound in a range from 0.1% to 20% with respect to the total weight of the solution.

29. The method according to claim 28, wherein the polar solution has a percentage by weight of the perfluorinated compound in a range from 0.5% to 15% with respect to the total weight of the solution.

30. The method according to claim 29, wherein the polar solution has a percentage by weight of the perfluorinated compound in a range from 0.5% to 10% with respect to the total weight of the solution.

31. The method according to claim 28, wherein the polar solution contains a catalytic quantity of inorganic acid.

32. The method according to claim 28, wherein the polar solution contains a catalytic quantity of organic acid.

33. The method according to claim 32, wherein the organic acid is acetic acid.

34. The method according to claim 28, wherein the step of heat treating the surface comprises heat treating the surface at a temperature below 150° C.

35. The method according to claim 34, wherein the step of heat treating the surface comprises heat treating the surface at a temperature in a range from 40° C. to 90° C.

36. The method according to claim 24, wherein the step of heat treating the surface comprises heat treating the surface for duration of less than 24 hours.

37. The method according to claim 36, wherein the step of heat treating the surface comprises heat treating the surface for duration in a range from 14 to 23 hours.
